(19) United States
(12) Patent Application Publication
(10) Pub. No.: US 2020/0044949 A1
(43) Pub. Date: Feb. 6, 2020

(54) Failover Mechanism for Real-Time Data Streams

(71) Applicants: Matthew Leigh GINSBERG, Eugene, OR (US); Martin Clemen DROHMANN, Eugene, OR (US)

(72) Inventors: Matthew Leigh GINSBERG, Eugene, OR (US); Martin Clemen DROHMANN, Eugene, OR (US)

(73) Assignee: Connected Signals, Inc., Eugene, OR (US)

(21) Appl. No.: 16/525,272

(22) Filed: Jul. 29, 2019

Related U.S. Application Data
(60) Provisional application No. 62/714,341, filed on Aug. 3, 2018.

(51) Int. Cl. H04L 12/26; G06N 7/00; G06N 5/04; H04L 12/24

(52) U.S. Cl. CPC H04L 43/0811; G06N 7/005; H04L 41/0668; H04L 43/04; G06N 5/04

(57) ABSTRACT

A system and method using a real-time data stream to make recommendations to users also predicts the future state of that data. If the data is interrupted or becomes unreliable, the predictions are used to make the recommendations in question.

### RELATED APPLICATIONS

This application claims priority from U.S. Provisional Patent Application Ser. No. 62/714,341, filed Aug. 3, 2018, entitled “Failover Mechanism for Real-Time Data Streams”. The above-identified application is incorporated herein by reference as if fully set forth herein.

### FIELD

The present disclosure relates generally to recovery from failures in real-time data streams that are used to provide users with guidance of one form or another.

### BACKGROUND

Data increasingly informs our daily life. In many cases, a continuous stream of data is used to provide advice regarding upcoming actions. For example, a data stream regarding the status of a traffic light can be used to warn a driver who is about to run that light inadvertently.

These data streams can be interrupted for a variety of reasons. Continuing with the traffic light example, the light may be communicating with the driver using a so-called traffic management center or “TMC” as an intermediary. If the light's connection with the

TMC is interrupted, the data stream available to the driver will stop. The connection can be interrupted by a maintenance activity at the TMC, by a cable being cut, or by any of a variety of software failures. In all of these cases, however, the light itself will continue operating in a standalone mode.

Where possible, it is desirable that the functionality provided to the user continues to operate even though the data stream itself has been interrupted. Continuing with our example, imagine that the light is perfectly pretimed, green in each direction for 42 seconds before turning to yellow for three seconds and then red for 45 seconds. In such a case, the future behavior of the light can be inferred from the previous behavior even if there is no actual data confirming this prediction.

### SUMMARY

A computer system and method analyze a data stream to make probabilistic predictions about that data stream's behavior. If the data stream is interrupted but the underlying physical process on which the data stream is based can be expected to continue operating, those predictions are used as a substitute for the data stream itself. Other aspects are also disclosed herein.

### BRIEF DESCRIPTION OF THE DRAWINGS

FIG. 1 is a high-level block diagram of a system in accordance with an embodiment described herein. It contains a data source 110 (in the figure, this data source is represented by a traffic light), a data mediator 120 (in the figure, a traffic management center), an analysis system 130, an aggregation and prediction mechanism 140, and a variety of user devices 150A, . . . ,150N.

FIG. 2 is a flow chart of a method in accordance with an embodiment described herein.

FIG. 3 is a block diagram illustrating an example of a computer for use as any of the computer-implemented components discussed herein, as detailed below.

One skilled in the art will readily recognize from the following discussion that alternative embodiments of the structures and methods illustrated herein may be employed without departing from the principles described herein.

### DETAILED DESCRIPTION

Embodiments disclosed herein provide systems, methods, and computer-readable storage media that allow physical devices to communicate with users. Embodiments include one-way or two-way communication via the Internet or other existing or to-be-developed communication mechanisms between user devices and an analysis system. Such user devices report recommendations, warnings, or other information to their operators or other devices.

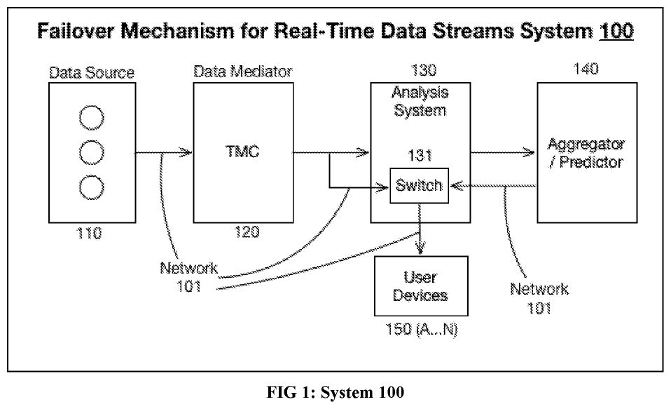

FIG. 1 is an illustration of one embodiment of such a system 100. The system includes a data source 110 (in the figure, this data source is represented by a traffic light), a data mediator 120 (in the figure, a traffic management center), an analysis system 130, an aggregation and prediction mechanism 140, and a variety of user devices 150A, . . . ,150N.

The arrows indicate some aspects of the communication among the various components, which may be by one or more networks 101, possibly comprising a local area network (LAN), a wide area network (WAN), a wireless network, an intranet, or the Internet, for example. The user devices 150 may include a computer terminal, a personal digital assistant (PDA), a wireless telephone, an on-vehicle computer, or various other user devices capable of connecting to the analysis system 130.

In one specific embodiment, the data source 110 is a traffic light, which is communicating over fiber optic cable with a data mediator 120 that is a traffic management center. The TMC then communicates over wired Internet with a remotely located analysis system 130 that is a general-purpose digital computer. The analysis system then passes the incoming data over a local network to another general-purpose digital computer that analyses the data to make probabilistic predictions about the future state of the data. The analysis system 130 also contains and controls a switch 131. The switch receives data both from the data mediator 120 and from the data predictor 140. Under the control of the analysis system, data from one of these data sources or the other is then passed to the user device 110. Again, in a specific embodiment, that is user device 110 is an iPhone® device provided by Apple, Inc. and programmed with a user-downloadable application providing traffic-light related functionality.

In some embodiments of the system 100, the real-time data stream to the data mediator 120 by the data source 110 and from the data mediator 120 to the analysis system 130 may involve pushing data. In other embodiments, data may be pulled by the respective components. In other embodiments a combination of methods may be used. The data stream transmissions may be synchronous or asynchronous, constant or on demand, or any combination of the above. Those skilled in the art will recognize other possibilities.

A variety of techniques can be used by the data aggregator/predictor 140. Predictions can be made using machine learning, Bayes nets, pattern matching, or a variety of other methods. In one specific embodiment, the predictions are made simply by searching for periods of time when the traffic light is operating in a purely pretimed mode, so that it is alternately green, yellow or red in various directions for a fixed amount of time. The light is then assumed to continue operating in that mode in the future. In another specific embodiment, specific days of the week and times of day (such as Monday-Friday, 7-LOAM) are identified during which the light is pretimed, and the light is assumed to be operating probabilistically (e.g., duration of a green light is randomly selected in a range from 15 to 60 seconds) at other times.

The switch 131 determines what data is provided to the user device. In some circumstances the data from the data stream from the data mediator 120 may be used to produce the data provided to the user device.

In some embodiments, the switch 131 may augmented the data from the data stream from the data mediator 120 with data sourced by the predictor 140 to produce the data provided to the user device.

In one embodiment, the data so provided is the data as received from the TMC, although very short-term predictions made by the predictor 140 may also be provided if, for example, the user device needs to recommend the speed required to reach the traffic light when it is green. Such recommendations need predictions about the behavior of the light over the next handful of seconds only.

In other circumstances, however, the data stream from the data mediator 120 may have stopped completely or may have been identified as unreliable for some reason. In such a case, the analysis system 130 causes the switch 131 to provide data as sourced by the predictive module 140 instead. In a specific embodiment, the data from the mediator is not checked for accuracy in any way and the switch to the data from by the predictor 140 is only undertaken if the data mediator's data stream is interrupted.

Those skilled in the art will recognize that the methods and systems described herein may be combined with other known techniques for identifying faulty data streams and for making predictions.

Implementation of some features described herein requires less than all of the subsystems and modules described above. For example, DSRC (dedicated short-range radio communication) or a cellular network connection can be used and may allow a traffic light to communicate directly with the analysis system 130, with no need for the data mediator 120. The fundamental principles of operation described here will continue to apply.

In the example discussed herein, the data stream from the data mediator 120 is as described in U.S. Pat. No. 9,852,624, NETWORK SECURITY SYSTEM WITH APPLICATION FOR DRIVER SAFETY SYSTEM, inventors Matthew L. Ginsberg et al., incorporated herein as Annex 1 below, and the entire contents of which forms part of this disclosure. In some embodiments, the data predictor 140 is implemented in whole or part as described above; in other embodiments it is implemented in whole or part using prediction as described in United States Patent Publication US 2018/0075739, TRAFFIC ROUTING DISPLAY SYSTEM WITH MULTIPLE SIGNAL LOOKAHEAD, inventors Matthew L. Ginsberg, et al., incorporated herein as Annex 2 below, and the entire contents of which forms part of this disclosure; and in yet other embodiments it is implemented in whole or part using prediction as described in U.S. patent application Ser. No. 15/988376, AUTOMATIC DETECTION OF TRAFFIC SIGNAL STATES FOR DRIVER SAFETY SYSTEM, inventors Matthew L. Ginsberg, et al., incorporated herein as Annex 3 below, and the entire contents of which forms part of this disclosure. In still other embodiments, the data stream described above and in particular such prediction implementations as described herein and therein (either singly or in combination) are used as primary mechanisms and others of such implementations (either singly or in combination) are used for failover as described herein. By way of example, in one embodiment a webcam-based implementation is used as the primary mechanism, but if weather or the webcam feed facility makes this data source unavailable a GPS-based prediction implementation is provided as a failover. Further, to increase robustness in some implementations various failover options are stacked, providing more than two potential sources from which traffic signal states may be determined.

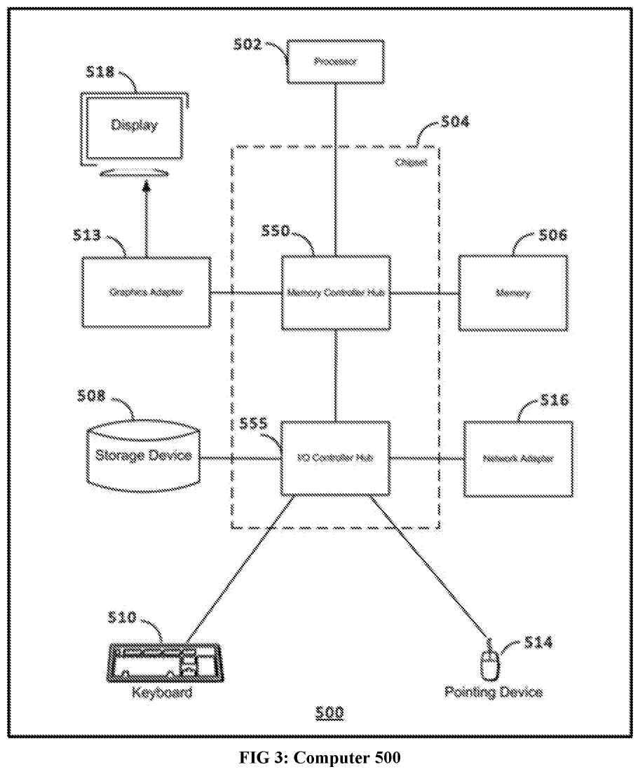

FIG. 3 is high-level block diagram illustrating an example of a computer 500 for use as an analysis system 130, predictive system 140, or user device 150 in accordance with an embodiment of system 100. Illustrated are at least one processor 502 coupled to a chipset 504. The chipset 504 includes a memory controller hub 550 and an input/output (I/O) controller hub 555. A memory 506 and a graphics adapter 513 are coupled to the memory controller hub 550, and a display device 518 is coupled to the graphics adapter 513. A storage device 508, keyboard 510, pointing device 514, and network adapter 516 are coupled to the I/O controller hub 555. Other embodiments of the computer 500 have different architectures. For example, the memory 506 is directly coupled to the processor 502 in some embodiments.

The storage device 508 is a computer-readable storage medium such as a hard drive, compact disk read-only memory (CD-ROM), DVD, or a solid-state memory device. The memory 506 holds instructions and data used by the processor 502. The pointing device 514 is a mouse, track ball, or other type of pointing device, and in some embodiments is used in combination with the keyboard 510 to input data into the computer system 500. The graphics adapter 513 displays images and other information on the display device 518. In some embodiments, the display device 518 includes a touch screen capability for receiving user input and selections. The network adapter 516 couples the computer system 500 to the network 101. Some embodiments of the computer 500 have different and/or other components than those shown in FIG. 3.

The computer 500 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 508, loaded into the memory 506, and executed by the processor 502.

The types of computers 500 used by the entities of FIG. 1 can vary depending upon the embodiment and the processing power used by the entity. For example, a user device 150 that is a PDA typically has limited processing power, a small display 518, and might lack a pointing device 514. The aggregator/predictor system 140, in contrast, may comprise multiple blade servers working together to provide the functionality described herein. As noted above, the portion of data storage and processing performed by each device is preferably based in part on the processing power and available communication bandwidth for each such device.

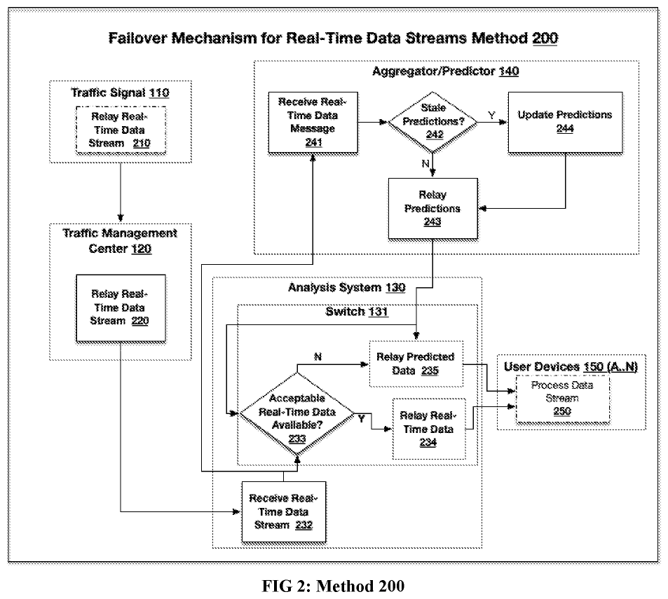

FIG. 2 is a flow chart of a method in accordance with one embodiment of the invention. In step 210, the real-time data stream is relayed from the data source 110 to the data mediator 120. In step 220, the real-time data stream is relayed from the data mediator 220 to the analysis system 130, where it is received in step 232, and forwarded to the aggregator/predictor 140 and the switch 131. In step 242 the aggregator/predictor 140 determines whether existing predictions need to be updated in light of the newly received real-time data; If so, step 244 updates the predictions. In step 243, the existing or updated predictions, as appropriate are relayed to the switch 131 as required.

In some embodiments of the invention, the data source 110 is connected wirelessly, or using some other network or networks 101, directly to the analysis system 130, and step 210 accordingly relays the real-time data stream directly to analysis system 130 where it is received by step 232.

In some embodiments of the method, the data source 110 may be a plurality of traffic signals. In some embodiments of the method, the data mediator 220 may be a traffic management center.

In some embodiments of the method 200, the relay of the real-time data stream in step 210 to the data mediator 120 by the data source 110 and the relay in step 220 from the data mediator 120 to the analysis system 130 may involve pushing data. In other embodiments, data may be pulled by the respective components. In other embodiments a combination of methods may be used. The data stream transmissions may be synchronous or asynchronous, constant or on demand, or any combination of the above. Those skilled in the art will recognize other possibilities.

In step 233, the switch 131 determines whether acceptable real-time data is available from the TMC. If so, real-time data, possibly modified in various ways, is relayed to user devices 150 in step 234. Otherwise, predicted data received from the aggregator/predictor 140 is relayed to the user devices 150 in step 235. In step 250, user devices 150 process the received data stream, whether live or predicted, responsive to the decision made in step 233.

In some embodiments of the method, the determination in step 233 may involve a simple test as to whether data is flowing from the data source. In other embodiments, that determination may test the amount and/or frequency of data received over a particular interval. In still other embodiments of the method, complex analysis of the quality or consistency of the data stream may be performed in step 233. In still other embodiments of the method, the complex analysis of the quality or consistency of the data may include comparisons with the predictions relayed in step 243. Those skilled in the art will recognize that the methods described herein may be combined with other known techniques for identifying faulty data streams.

In step 241, a possibly modified relay of the data stream is received from the analysis system 130 by the aggregator/predictor 140. Based on information available to the aggregator/predictor 140, step 242 determines whether the new data received indicates that the predictions that are currently available are out of date in any way. If not, step 243 relays such predictions as currently available to the analysis system 130, where they become available for relay if necessary in step 235. If the current predictions are out of date, step 244 updates the predictions and/or predictive models to reflect the new data received in step 241, and updated predictions are relayed in step 243.

The determination in step 242 may involve consistency checking of the received data with the information already available to the aggregator/predictor 140, machine learning or statistical techniques, or other methods that will be known to one skilled in the art.

The update of predictions in step 244 may involve techniques from machine learning or statistics or other known methods for updating predictive models. Those skilled in the art will recognize other methods for updating predictive models.

It should be noted that the discussion above has focused on traffic signals (i.e., traffic lights) as the source of the data stream, but the disclosure here applies to other types of data streams as well.

The present disclosure has been provided in particular detail with respect to several possible embodiments. Those of skill in the art will appreciate that other embodiments may be practiced as well. The particular naming of the components, capitalization of terms, the attributes, data structures, or any other programming or structural aspect is not mandatory or significant, and the mechanisms that implement any particular embodiment or its features may have different names, formats, or protocols. Further, the embodiments may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

The present disclosure references apparatus for performing certain operations. In some circumstances, the disclosure indicates that such apparatus is specially constructed for the required purposes; other aspects may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk, including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present disclosure should not be read to be limited to any particular programming language. It is appreciated that a variety of programming languages may be used to implement the teachings as described herein, and any references to specific languages are provided for enablement and best mode.

The embodiments disclosed are well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

1. A system for improving the effective stability of a real-time data stream, comprising:
a real-time data stream;
a first analysis system that uses said data stream to make real-time recommendations to a plurality of users;
a predictive system that uses said data stream itself to make and store probabilistic predictions regarding the data stream's future contents;
a second analysis system that uses the probabilistic predictions to make recommendations to the plurality of users; and
a switch that monitors the data stream to identify circumstances where the data has become unreliable, and makes recommendations based on the first analysis system when the data stream is reliable and based on the second analysis system when the data stream is not reliable.

2. The system of claim 1, wherein the monitoring identifies times when the data stream is unreliable because it has been interrupted.

3. The system of claim 1, where the predictive system only makes predictions when the future behavior of the data stream can be predicted with certainty.

4. The system of claim 1, where the data stream identifies the state of a traffic light.

5. The system of claim 4, where the predictions are based on the identification of specific timing patterns in the behavior of the traffic light.

6. A method for improving the effective stability of a real-time data stream, comprising:
use of a real-time data stream to make real-time recommendations to a plurality of users;
using the data stream itself to make and store probabilistic predictions regarding the data stream's future contents;
monitoring the data stream to identify circumstances where the data has become unavailable or unreliable; and
making the recommendations based on the probabilistic predictions at such times.

7. The method of claim 6, wherein the monitoring identifies times when the data stream has been interrupted.

8. The method of claim 6, where the predictions are made only when the future behavior of the data stream can be predicted with certainty.

9. The method of claim 6, where the data stream identifies the state of a traffic light.

10. The method of claim 9, where the predictions are based on the identification of specific timing patterns in the behavior of the traffic light.

11. A method for improving an effective stability of a real-time data stream comprising a sequential series of data elements, comprising:
receiving a sequence of real data elements from a data source;
computing a sequence of predictive data elements based on earlier-received real data elements, each predictive data element of the sequence thereof corresponding to an expected real data element and computed in advance of or contemporaneously with an expected arrival time of the expected real data element;
when the expected real data element arrives at the expected arrival time, selecting the expected real data element as an output data element;
when the expected real data element does not arrive at the expected arrival time, selecting the predictive data element as the output data element; and
computing a recommendation based on the output data element; and
transmitting the recommendation to at least one client user.

12. The method of claim 11, further comprising:
basing the recommendation on elements of the output data element and the predicted data element

13. The method of claim 12, further comprising:
when the expected real data element arrives at the expected arrival time, comparing the expected real data element with the predictive data element to produce a discrepancy; and
applying the discrepancy to the computing operation to improve an accuracy of the sequence of predictive data elements.

14. The method of claim 12, further comprising:
when the expected real data element arrives at the expected arrival time, comparing the expected real data element with the predictive data element to produce a discrepancy; and
when the discrepancy exceeds a certain threshold selecting the predictive data element instead of the expected real data element.
